(19) United States
(12) Patent Application Publication
(10) Pub. No.: US 2010/0078858 A1
(43) Pub. Date: Apr. 1, 2010

(54) MOLD STRUCTURE, AND IMPRINT METHOD AND MAGNETIC TRANSFER METHOD USING THE SAME

(75) Inventor: MASAKAZU NISHIKAWA, KANAGAWA (JP)

Correspondence Address: YOUNG & THOMPSON, 209 Madison Street, Suite 500, Alexandria, VA, 22314, US

(73) Assignee: FUJIFILM CORPORATION, TOKYO (JP)

(21) Appl. No.: 12/568,932

(22) Filed: Sep. 29, 2009

(30) Foreign Application Priority Data
Sep. 29, 2008 (JP) 2008-250260

(51) Int. Cl. B29C 59/16; B28B 17/00

(52) U.S. Cl. 264/427; 425/3

(57) ABSTRACT

A mold structure including a disc-shaped base material; a concavo-convex pattern formed on one surface of the base material; and a member extendable and contractible by an external force.

### BACKGROUND OF THE INVENTION

1. Field of the Invention

The present invention relates to a mold structure having a concavo-convex pattern for transferring information to a magnetic recording medium, and an imprint method and magnetic transfer method using the mold structure.

2. Description of the Related Art

A magnetic transfer method is proposed as a method of recording a servo signal to a high-recording-density medium (see Japanese Patent Application Laid-Open (JP-A) No. 11-25455). By the proposed method, the servo signal can be recorded collectively for a short time.

Moreover, discrete track media (DTM) and bit patterned media (BPM) are proposed in which a magnetic layer is patterned to enhance recording density (see, for example, Japanese Patent Application Laid-Open (JP-A) Nos. 09-97419 and 2006-120299). In these DTM and BPM, the magnetic layer is patterned for a servo signal area as well as a data area.

In both techniques of DTM and BPM, it is necessary to achieve a closely attached state in which a magnetic transfer master or a mold structure is uniformly and extremely closely attached to an object to be processed in wide area. So far, the closely attached state is maintained in such a manner that on a holder which is processed into a polar plane, a cushion material having elasticity and either a magnetic transfer master or mold structure are placed with respect to an object to be processed, and then high pressure is dynamically applied thereto, so as to locally deform the magnetic transfer master or the mold structure. With such a method, the closely attached state is left to chance and thus, depends on many factors such as the shape of the magnetic transfer master or the mold structure, and the state of the object to be processed, making it difficult to realize a uniform, stable closely attached state.

### BRIEF SUMMARY OF THE INVENTION

An object of the present invention is to provide a mold structure provided with a member extendable and contractible by an external force to selectively and actively apply an external force to a part of the mold structure, which is not sufficiently closely attached to an object to be processed, so as to maintain a uniform, stable closely attached state, and an imprint method and a magnetic transfer method using the mold structure.

Means for solving the problems are as follows.

<1> A mold structure including a disc-shaped base material, a concavo-convex pattern on one surface of the base material, and a member extendable and contractible by an external force, wherein the concavo-convex pattern comprises a concavo-convex portion.
<2> The mold structure according to <1>, wherein the member extendable and contractible by the external force is provided on a surface of the mold structure, which surface is opposite to the surface having the concavo-convex pattern.
<3> The mold structure according to <1>, wherein the external force is any one of a magnetic field and an electric field.
<4> The mold structure according to <1>, wherein the member extendable and contractible by the external force is any one of a piezoelectric element and a giant-magnetostriction element.
<5> The mold structure according to <1>, wherein the mold structure is any one of a magnetic transfer master, an imprint mold for a discrete track medium (DTM), and an imprint mold for a bit patterned medium BPM.
<6> An imprint method including pressing a mold structure against an imprint resist layer of an magnetic recording medium intermediate, and applying any one of a magnetic field and an electric field to a member of the mold structure which member is extendable and contractible by an external force, so as to transfer a concavo-convex pattern onto the imprint resist layer correspondingly to a concavo-convex pattern of the mold structure, wherein the mold structure includes a disc-shaped base material; the concavo-convex pattern on one surface of the base material; and the member extendable and contractible by the external force, wherein the concavo-convex pattern includes a concavo-convex portion, and wherein the magnetic recording medium intermediate includes a substrate, a magnetic layer on the substrate, and the imprint resist layer formed of an imprint resist composition over the substrate.
<7> A method for producing a magnetic recording medium by using an imprint method which includes pressing a mold structure against an imprint resist layer of an magnetic recording medium intermediate, and applying any one of a magnetic field and an electric field to a member of the mold structure which member is extendable and contractible by an external force, so as to transfer a concavo-convex pattern onto the imprint resist layer correspondingly to a concavo-convex pattern of the mold structure, wherein the mold structure includes a disc-shaped base material; the concavo-convex pattern on one surface of the base material; and the member extendable and contractible by the external force, wherein the concavo-convex pattern includes a concavo-convex portion, and wherein the magnetic recording medium intermediate includes a substrate, a magnetic layer on the substrate; and the imprint resist layer formed of an imprint resist composition over the substrate.
<8> A magnetic recording medium obtained by a method for producing a magnetic recording medium using an imprint method, which includes pressing a mold structure against an imprint resist layer of an magnetic recording medium intermediate, and applying any one of a magnetic field and an electric field to a member of the mold structure which member is extendable and contractible by an external force, so as to transfer a concavo-convex pattern onto the imprint resist layer correspondingly to a concavo-convex pattern of the mold structure, wherein the mold structure includes a disc-shaped base material; the concavo-convex pattern on one surface of the base material; and the member extendable and contractible by the external force, wherein the concavo-convex pattern includes a concavo-convex portion, and wherein the magnetic recording medium intermediate includes a substrate, a magnetic layer on the substrate, and the imprint resist layer formed of an imprint resist composition over the substrate.
<9> A magnetic transfer method including initially magnetizing a magnetic recording medium, superposing and closely attaching a mold structure to the initially magnetized magnetic recording medium by applying any one of a magnetic field or an electric field to a member of the mold structure which member is extendable and contractible by an external force, and applying a magnetic field to the mold structure and the magnetic recording medium which are closely attached to each other so as to magnetically transfer magnetic information to the magnetic recording medium, wherein the mold structure includes a disc-shaped base material; a concavo-convex pattern on one surface of the base material; and the member extendable and contractible by the external force, and wherein the concavo-convex pattern includes a concavo-convex portion.
<10> A magnetic recording medium obtained by a magnetic transfer method including initially magnetizing a magnetic recording medium; superposing and closely attaching a mold structure to the initially magnetized magnetic recording medium by applying any one of a magnetic field or an electric field to a member of the mold structure which member is extendable and contractible by an external force, and applying a magnetic field to the mold structure and the magnetic recording medium which are closely attached to each other so as to magnetically transfer magnetic information to the magnetic recording medium, wherein the mold structure includes a disc-shaped base material; a concavo-convex pattern on one surface of the base material; and the member extendable and contractible by the external force, and wherein the concavo-convex pattern includes a concavo-convex portion.

According to the present invention, conventional problems can be solved, and a member extendable and contractible by an external force is provided in the mold structure so as to selectively and actively apply an external force to a part of the mold structure, which is not sufficiently closely attached to an object to be processed, thereby maintaining a uniform stable closely attached state, and an imprint method and a magnetic transfer method using the mold structure.

### BRIEF DESCRIPTION OF THE DRAWINGS

FIG. 1 is a partially cross-sectional view showing an example of a mold structure of the present invention.

FIGS. 2A to 2E are process drawings showing a step of producing an original master in a method for producing a mold structure of the present invention.

FIGS. 3A to 3E are process drawings showing a step of producing a mold in the method for producing a mold structure of the present invention.

FIG. 4A is a cross-sectional schematic diagram showing a state before a step of transferring a concavo-convex shape of a mold structure in a method for producing a magnetic recording medium.

FIG. 4B is a cross-sectional schematic diagram showing a state after a step of transferring the concavo-convex shape of the mold structure in the method for producing a magnetic recording medium.

FIG. 4C is a cross-sectional schematic diagram showing a reactive ion etching step in the method for producing a magnetic recording medium.

FIG. 4D is a cross-sectional schematic diagram showing a step of cutting a magnetic layer in the method for producing a magnetic recording medium.

FIG. 4E is a cross-sectional schematic diagram showing a step of producing a magnetic recording medium having a concavo-convex pattern by removing the resist layer, on the magnetic layer in the method for producing a magnetic recording medium.

FIG. 5 is an explanatory view showing a magnetization direction of the magnetic layer (recording layer) after an initially magnetizing step.

FIG. 6 is an explanatory view showing a magnetic transfer step.

FIG. 7 is a schematic structural view of a magnetic transfer apparatus used in the magnetic transfer step.

FIG. 8 is an explanatory drawing showing the magnetization direction of the magnetic layer (recording layer) after the magnetic transfer step.

### DETAILED DESCRIPTION OF THE INVENTION

### Mold Structure

A mold structure of the present invention includes a disc-shaped base material, and a concavo-convex pattern on one surface of the base material, wherein the concavo-convex pattern includes a concavo-convex portion, and further includes other members, as necessary.

Examples of the mold structure include a magnetic transfer master, an imprint mold for a discrete track medium (DTM), and an imprint mold for a bit patterned medium (BPM).

In the present invention, the mold structure is provided with a member extendable and contractible by an external force. It is preferably provided on a surface of the mold structure, which surface is opposite to the surface having the concavo-convex pattern. As a result, the external force is selectively and actively applied to the part of the mold structure, which is insufficiently closely attached to an object to be processed, so as to maintain uniform and stable closely attached state.

A method for attaching the member extendable and contractible by an external force to the mold structure is not particularly limited, and may be suitably selected according to the purpose. Examples thereof include vacuum film deposition, such as sputtering, vapor deposition, and ion plating, CVD; and an attaching method using a tackiness agent, when the member extendable and contractible by an external force has a bulk-like property.

The external force is preferably any one of a magnetic field and an electric field. The member extendable and contractible by an external force is preferably is any one of a piezoelectric element and a giant-magnetostriction element.

The piezoelectric element means a passive element using piezoelectric effect that a force applied to a piezoelectric body is converted into an electric voltage, and an electric voltage is converted into force. Examples of the piezoelectric element include quartz, zinc oxide, lithium niobate, lithium tantalite and lead zirconate titanate.

The giant-magnetostriction element is an element which utilizes a phenomenon that the magnetization force of a magnetic material is changed to occur distortion (deformation, shape variation), and particularly, the amount of displacement is 1,000 times (1,000 ppm) or more than in the original one. For example, alloys containing at least two elements such as Tb, Dy, Fe, Ga, or the like are preferable. Among these, Dy—Tb—Fe alloy material, which is a composition of TERFENOL-D is particularly preferable. In this case, a non-magnetic underlying layer using a metal containing at least one element such as Nb, Ta, or the like may be formed to enhance magnetostriction effect.

In the case of the vacuum film deposition, to enhance an adhesion force between the mold structure and the member extendable/contractible by an external force, a surface of the mold structure may be cleaned using gas such as argon, oxygen, or the like before the member is formed. Moreover, to enhance electrostriction or magnetostriction property of the member extendable/contractible by an external force, a non-magnetic orientation underlying layer may be provided.

In the case of adhesion, various pressure sensitive adhesive sheets, adhesives, or the like can be used. An epoxy resin having small thermal expansion coefficient is preferably used

The material of the mold structure is not particularly limited, and may be suitably selected according to the purpose. A quartz, metal and resin are particularly preferable.

As the metal, various metals such as Ni, Cu, Al, Mo, Co, Cr, Ta, Pd, Pt, Au and the like, or alloys thereof can be used. Among these, Ni, and Ni alloys are particularly preferable.

Examples of the resin include polyethylene terephthalate (PET), polyethylene naphthalate (PEN), polycarbonate (PC), and a fluorine resin having a low melting point.

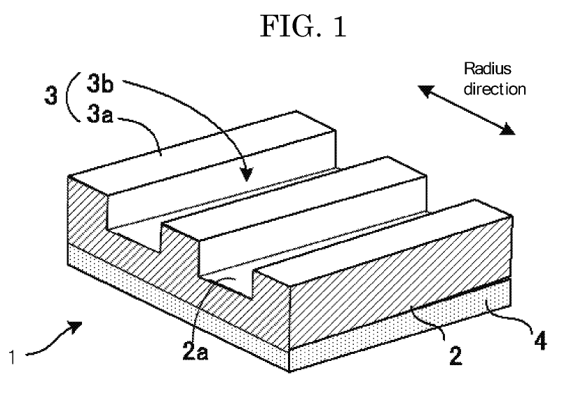

Here, FIG. 1 is a partially cross-sectional view showing an embodiment of a mold structure of the present invention.

In FIG. 1, a mold structure 1 includes a plurality of convex portions 3a and concave portions 3b formed in a concentric pattern on one surface 2a (hereinafter, also referred to as “reference surface 2a”) of a disc-shaped base material 2. Here, a convex portion 3a and a concave portion 3b formed between a plurality of convex portions 3a are collectively referred to as a concavo-convex portion 3.

To the other surface of the base material, in which no concavo-convex pattern is formed, a member extendable/contractible by an external force 4 is attached by sputtering.

The shape of a vertical cross-section of the convex portion 3a is not limited to rectangle, and may be adjusted to any shape by controlling the etching process described below, depending on the purpose.

In the present invention, “(shape of) cross-section” of the convex portion 3a indicates, unless otherwise stated, the (shape of) vertical cross-section of the convex portion 3a in an alignment direction (the direction in which the convex portions 3a are disposed one after another).

Furthermore, the base material 2 preferably has a thickness of 0.5 mm to 10 mm.

### <Production Method of Mold Structure>

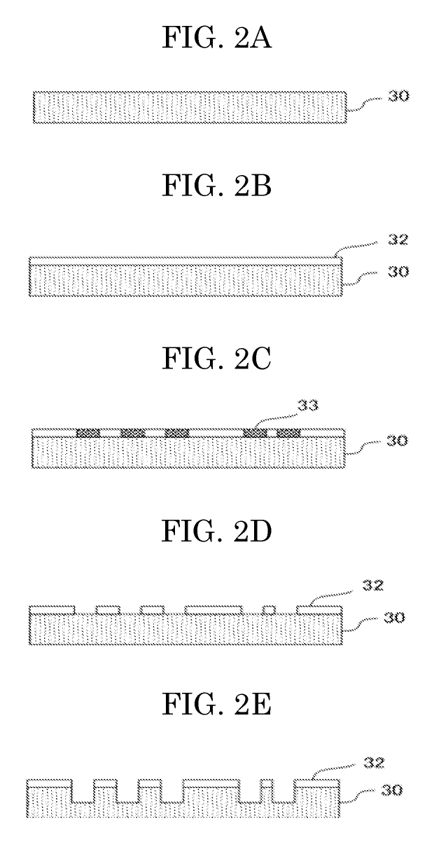

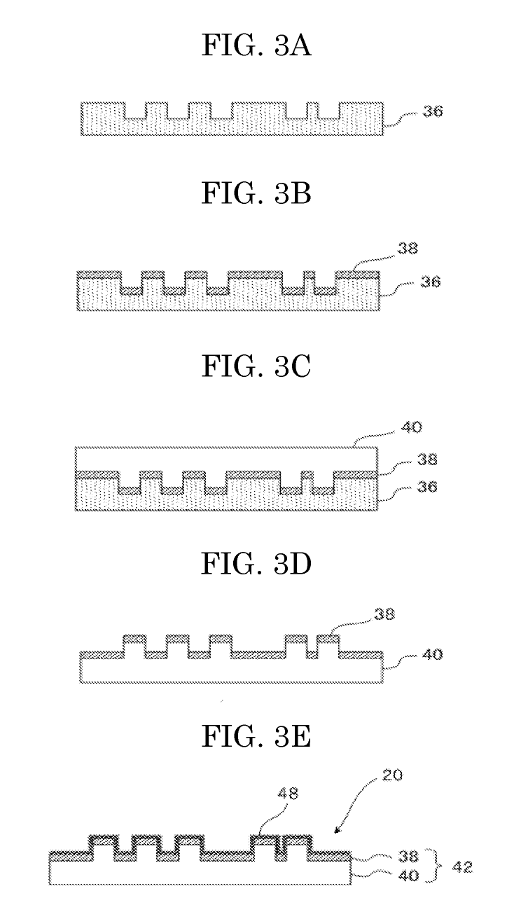

Here, FIGS. 2A to 2E and FIGS. 3A to 3E are process drawings showing an example of a method for producing a mold structure of the present invention. FIGS. 2A to 2E show a step of producing an original master, and FIGS. 3A to 3E show a step of producing a mold.

As shown in FIG. 2A, an original plate (Si substrate) 30, which is a silicon wafer whose surface is smooth, is prepared, an electron beam resist solution is applied onto the original plate 30 by spin coating or the like so as to form a resist layer 32 thereon (see FIG. 28), and the resist layer 32 is baked (pre-baked).

Next, the original plate 30 is set on a high-precision rotary stage or X-Y stage provided in an electron beam exposure apparatus (not shown), an electron beam modulated correspondingly to a servo signal is applied while the original plate 30 is being rotated, and a predetermined pattern 33 is formed on the substantially entire surface of the resist layer 32; for example, a pattern that corresponds to a servo signal and that linearly extends in radius directions from the rotational center toward each track is formed at portions corresponding to frames on the circumference by writing exposure (electron beam writing) (see FIG. 2C).

Subsequently, as shown in FIG. 2D, the resist layer 32 is developed, the exposed (written) portions are removed, and a coating layer having a desired thickness is formed by the remaining resist layer 32. This coating layer serves as a mask in a subsequent step (etching step). Additionally, the resist applied onto the original plate 30 can be of positive type or negative type; it should be noted that an exposed (written) pattern formed when a positive resist is used is an inversion of an exposed (written) pattern formed when a negative resist is used. After this developing process, a baking process (post-baking) is carried out to enhance the adhesion between the resist layer 32 and the original plate 30.

Subsequently, as shown in FIG. 2E, part of the original plate 30 is removed (etched) from an opening portion of the resist layer 32, such that hollows having a predetermined depth are formed in the original plate 20. As to this etching, anisotropic etching is desirable in that an undercut (side etching) can be minimized. Reactive ion etching (RIE) can be suitably employed as such anisotropic etching.

Thereafter, as shown in FIG. 3A, the resist layer 32 is removed. As to the method for removing the resist layer 32, ashing can be employed as a dry method, and a removal method using a release liquid can be employed as a wet method. By the ashing process, an original master 36 on which an inversion of a desired concavo-convex pattern is formed is produced.

Here, the original master 36 is washed with purified water, and then dried.

Subsequently, as shown in FIG. 3B, a conductive layer 38 is formed on the surface of the original master 36 so as to have a uniform thickness. The method for forming the conductive layer 38 can be suitably selected from various metal deposition methods, including PVD (physical vapor deposition), CVD (chemical vapor deposition), sputtering and ion plating. Formation of one layer of the conductive layer 38, as described above, makes it possible to obtain such an effect that a metal can be uniformly electrodeposited in a subsequent step (electroforming step). The conductive layer 38 is preferably a film formed mainly of Ni. Since such a film composed mainly of Ni can be easily formed and is hard, it is suitable as the conductive film. The thickness of the conductive layer 38 is not particularly limited; generally though, the thickness is several tens of nanometers or so.

In the formation of the conductive layer, an underlying layer (a release layer, either inorganic or organic) for assisting separation may be provided between the substrate and the conductive layer, as long as it does not affect final quality, i.e. quality of the magnetic recording medium.

Then, as shown in FIG. 30, a metal plate 40 made of a metal (Ni in this case), which has a desired thickness, is laid over the surface of the original master 36 by electroforming (reversed plate forming step). This step is performed by immersing the original master 36 in an electrolytic solution placed in an electroforming device, utilizing the original master 36 as an anode, and passing an electric current between the anode and a cathode. The concentration of the electrolytic solution, the pH, the manner in which the electric current is applied, etc. are required to be adjusted under an optimized condition where the laid metal plate 40 does not warp.

The original master 36 over which the metal plate 40 has been laid as described above is taken out from the electrolytic solution in the electroforming device and then immersed in purified water placed in a release bath (not shown).

Subsequently, in the release bath, the metal plate 40 is separated from the original master 36 (separating step), and a replicated metal plate 42 having a concavo-convex pattern which is an inversion of the concavo-convex pattern of the original master 36 is thus obtained as shown in FIG. 3D.

Here, the original master after separation is washed with purified water, and dried to be in an initial state. The original master of the initial state is repeatedly processed from the step of forming the conductive layer, so that a plurality of metal plates can be produced using one original master.

In this way, as the mold structure the imprint mold for a discrete track medium (DTM) or the imprint mold for a bit patterned medium (BPM) was produced.

On the other hand, when the mold structure is produced as the magnetic transfer master (hereinafter, also referred to as a master disk), as shown in FIG. 3E, a magnetic layer 48 is formed on the concavo-convex surface of the replicated metal plate 42. Examples of the material for the magnetic layer 48 include CoPt. The thickness of the magnetic layer 48 is preferably 10 nm to 320 nm, more preferably 20 nm to 300 nm, even more preferably 30 nm to 100 nm. The magnetic layer 48 is formed by sputtering, using a target made of the above-mentioned material.

Thereafter, the replicated metal plate 42 is subjected to punching such that its inner and outer diameters have predetermined sizes. By the above-mentioned process, a magnetic transfer master 20 as the mold structure having the concavo-convex pattern provided with the magnetic layer 48 is produced as shown in FIG. 3E.

A concavo-convex pattern is formed on the surface of the mold structure, which is any one of the magnetic transfer master, the imprint mold for a discrete track medium (DTM), and the imprint mold for a bit patterned medium (BPM).

Also, although not shown therein, a protective layer made of diamond-like carbon or the like may be provided over the mold, and further, a lubricant layer may be provided over the protective film.

Specifically, a preferred structure is as follows: a carbon film having a thickness of 2 nm to 30 nm is formed as a protective layer, and a lubricant layer is formed thereon. Also, in order to enhance the adhesion between the magnetic layer 48 and the protective layer, an adhesion enhancing layer of Si or the like may be formed on the magnetic layer 48 before forming the protective layer.

Next, on the surface of the mold structure which is any one of the magnetic transfer master, the imprint mold for a discrete track medium (DTM), and the imprint mold for a bit patterned medium (BPM), which surface is opposite to the surface having the concavo-convex pattern, a member extendable/contractible by an external force is attached by sputtering or the like.

The mold structure produced by the method for producing a mold structure of the present invention is preferably used as any one of the magnetic transfer master, the imprint mold for a discrete track medium (DTM), and the imprint mold for a bit patterned medium (BPM).

### —Imprint Mold for DTM (or BPM)—

In the case where the thus obtained mold structure is used as a mold for DTM (or BPM), a release agent is formed into a thin film on a surface having the concavo-convex pattern of the metal plate (releasing process), and the thin film formed on the metal plate is closely attached to a resin film formed on a substrate, which has been separately prepared, and then is heated or irradiated with LTV, so as to transfer the shape of the concavo-convex pattern on the resin film (imprint process).

The remaining film in the bottom of the concave portion of the resin film is removed by etching, and then the substrate is etched with the pattern of the resin film serving as a mask. Subsequently, the resin film is removed by ashing process, and if necessary, a magnetic layer or a non-magnetic layer is filled in a patterned groove and a surface of the layer is planarized by CMP or the like (planarization process), so as to produce a magnetic recording medium (DTM or BPM).

### (Imprint Method)

The imprint method of the present invention includes pressing the mold structure of the present invention against an imprint resist layer of a magnetic recording medium intermediate, which includes a substrate, a magnetic layer on the substrate and the imprint resist layer formed of an imprint resist composition over the substrate, and applying a magnetic field or an electric field to the member of the mold structure which member is extendable/contractible by an external force, so as to transfer a concavo-convex pattern onto the imprint resist layer correspondingly to the concavo-convex pattern formed in the mold structure, and if necessary further includes other steps.

The conditions of applying the magnetic field or the electric field to the member of the mold structure, which member is extendable/contractible by an external force are as follows:

When the magnetic field is applied as the external force, a magnetic field generated from an electromagnet or a permanent magnet is used. A magnetic field generator is rotated so as to apply a magnetic field to the whole area of a holder. The intensity of the magnetic field to be applied is preferably 1.1×Ha to 1.9×Ha, and more preferably 1.5×Ha to 1.7×Ha, where Ha denotes a magnetic field value at which a magnetostriction value is saturated in a magnetic field/magnetostriction curve of a giant-magnetostriction element.

When the electric field is externally applied, an electric potential is applied to the mold structure and the holder which holds the mold structure, so as to generate an electric field. The amount of electric field is adjusted by changing the intensity of electric potential. The voltage applied is 100 V.

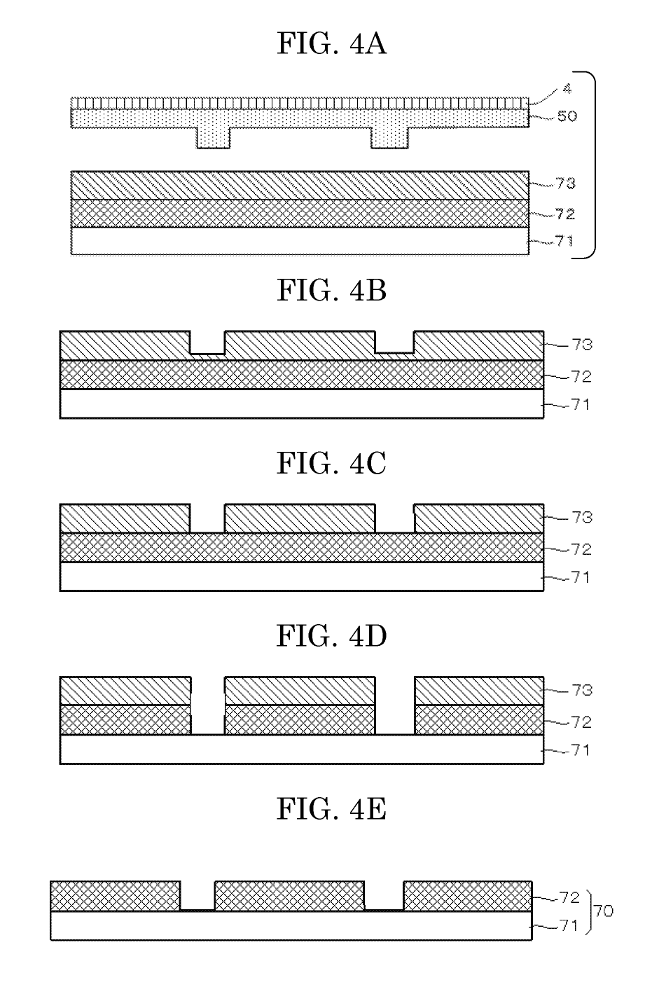

Here, FIGS. 4A to 4E are cross-sectional schematic diagrams for describing a method for producing a magnetic recording medium by an imprint method.

First, as shown in FIG. 4A, a resist layer 73 is formed by spin coating over a substrate 71 for forming a magnetic recording medium, on which surface a magnetic layer 72 is formed (a magnetic recording medium intermediate 75). A mold structure 50 of the present invention is pressed against the resist layer 73, and then any one of a magnetic field and an electric field is applied to the member extendable/contractible by an external force 4 of the mold structure, so as to transfer a concavo-convex pattern onto the resist layer 73. Upon transferring, the resist layer is heated at a temperature higher than a glass transition temperature of a resin constituting the resist layer, so that the resist layer is softened, thereby establishing a state where the shape of the resist layer can be easily changed.

The magnetic recording medium intermediate 75 includes at least the magnetic layer 72 and the resist layer 73, which are formed over the substrate 71, and further includes suitably selected other layers as necessary.

The material for the magnetic layer is not particularly limited and may be suitably selected from known materials therefor according to the purpose. Suitable examples thereof include Fe, Co, Ni, FeCo, FeNi, CoNi, CoNiP, FePt, CoPt and NiPt. These may be used individually or in combination.

The material for the resist layer may be any one of a positive resist material or a negative resist material.

As shown in FIG. 4B, onto the surface of the resist layer 73, a concavo-convex shape of the mold (stamper) 50 of the present invention is transferred. At this moment, on the bottom of the concave portions of the resist layer 73, a residual resist is left.

Next, as shown in FIG. 4C, the residual resist on the bottom of the concave portions is removed by reactive ion etching, so as to expose the magnetic layer 72.

Next, as shown in FIG. 4D, the exposed portions of the magnetic layer are cut in a vertical direction to the substrate corresponding to the concave portions by ion milling using Ar or the like, with the concavo-convex shape on the resist layer 73 serving as a mask.

Next, as shown in FIG. 4E, the resist layer 73 on the convex portions of the magnetic layer 72 is removed so as to obtain a discrete magnetic recording medium 70 having a concavo-convex pattern. The concave portions of the magnetic layer are filled with SiO₂, carbon, alumina; a polymer such as poly (methyl methacrylate) (PMMA), polystyrene (PS); and a non-magnetic material such as smoothing oil, so as to planarize the surface thereof. On the planarized surface, a protective layer is formed using diamond-like carbon (DLC) or the like, and finally a lubricant is applied. Thus, a magnetic recording medium is produced.

In the imprint method, by the use of the mold structure of the present invention, an exact concavo-convex pattern (track for recording data) can be formed with high precision.

### —Magnetic Transfer Master—

When the mold structure is produced as a magnetic transfer master (hereinafter, also referred to as a master disk), a magnetic layer is preferably formed on a surface of the concavo-convex pattern formed in the metal plate.

The material for the magnetic layer is not particularly limited and may be suitably selected from known materials therefor according to the purpose. Suitable examples thereof include Co, Co alloys (CoNi, CoNiZr, CoNbTaZr, or the like), Fe, Fe alloys (FeCo, FeCoNi, FeNiMo, FeAlSi, FeAl, FeTaN, or the like), Ni, Ni alloys (NiFe, or the like). Of these, FeCo, and FeCoNi are particularly preferred.

The method for forming the magnetic layer is not particularly limited, and the magnetic layer may be formed in accordance with a known method. Examples thereof include vacuum film deposition, such as vacuum vapor deposition, sputtering, and ion plating; plating; and coating.

The thickness of the magnetic layer is not particularly limited and may be suitably selected according to the purpose. It is preferably 5 nm to 200 nm, and more preferably 10 nm to 150 nm.

It is preferred that a protective layer, which is formed of diamond-like carbon (DLC), sputter carbon, or the like, be formed on the magnetic layer. A lubricant layer may be further formed on the protective layer. In this case, a preferable structure is such that a DLC film having a thickness of 3 nm to 30 nm and serving as the protective layer, and the lubricant layer are combined with each other. Between the magnetic layer and the protective layer, an adhesion enhancing layer of Si or the like may be formed. The lubricant layer has the effect of preventing decrease in durability, for example, generation of scratches attributed to friction caused by correcting displacement which occurs in the process of bringing the master disk into contact with the recording medium (hereinafter also referred to as a slave disk).

### (Magnetic Transfer Method)

A magnetic transfer method of the present invention includes at least an initially magnetizing step, that is initially magnetizing the magnetic recording medium, a closely attaching step, that is superposing and closely attaching the mold structure of the present invention to the initially magnetized magnetic recording medium by applying any one of a magnetic field or an electric field to a member of the mold structure which member is extendable and contractible by an external force, and a magnetic transfer step, that is applying a magnetic field to the mold structure and the magnetic recording medium which are closely attached to each other so as to magnetically transfer magnetic information to a magnetic layer of the magnetic recording medium; and further includes other steps as necessary.

The conditions of applying the magnetic field or the electric field to the member of the mold structure which member is extendable/contractible by an external force are as follows:

When the magnetic field is applied as the external force, a magnetic field generated from an electromagnet or a permanent magnet is used. A magnetic field generator is rotated so as to apply a magnetic field to the whole area of a holder. The intensity of a magnetic field to be applied is preferably 1.1×Ha or more, and more preferably 1.5×Ha or more, where Ha denotes a magnetic field value (Ha) at which a magnetostriction value is saturated in a magnetic field/magnetostriction curve of a giant-magnetostriction element. Additionally, a magnetic transfer field may be used.

When the electric field is externally applied, an electric potential is applied to the mold structure and the holder which holds the mold structure, so as to generate an electric field. The amount of electric field is adjusted by changing the intensity of electric potential. The voltage applied is 100 V.

### <Initially Magnetizing Step>

The initially magnetizing step is a step of initially magnetizing a magnetic to recording medium in a perpendicular direction.

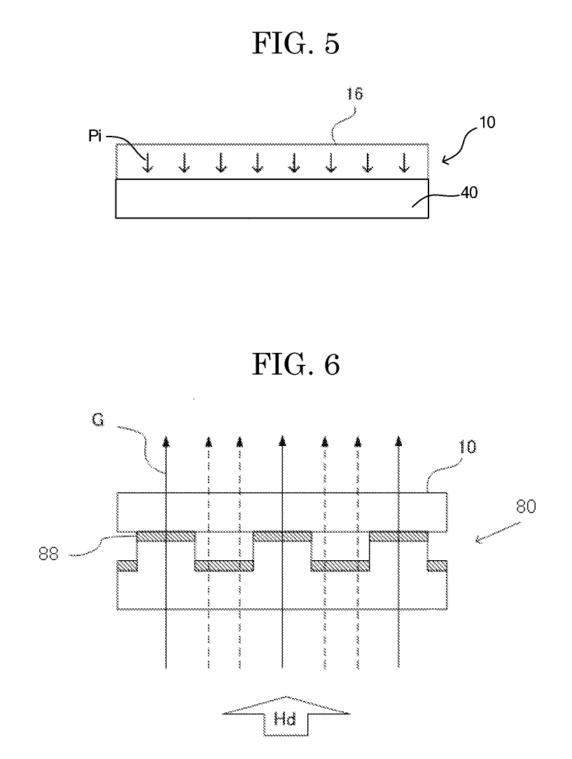

By this initially magnetizing step, a magnetic layer 16 of a magnetic recording medium (hereinafter, also referred to as a slave disk 10), which includes a metal plate 40 and the magnetic layer 16, is subjected to an initial magnetization Pi in one direction perpendicular to the disk surface, as shown in FIG. 5. It should be noted that this initially magnetizing step may be carried out by rotating the slave disk 10 relatively to the magnetic field applying unit.

### <Closely Attaching Step>

The closely attaching step is a step of superposing and closely attaching a magnetic transfer master (hereinafter, also referred to as a master disk) to the initially magnetized magnetic recording medium. In the closely attaching step, the surface of the master disk on which the protrusion pattern (concavo-convex pattern) is formed and the surface of the slave disk on which the magnetic layer is formed are laid one on top of the other through application of a predetermined pressing force, and the master disk is closely attached to the slave disk by applying any one of the magnetic field or the electric field to the member of the master disk which member is extendable and contractible by an external force (not shown).

Before closely attached to the master disk, the slave disk is subjected to a cleaning process (burnishing or the like) in which minute protrusions or attached dust on its surface is removed using a glide head, a polisher, etc, as necessary.

As to the closely attaching step, there is a case in which the master disk is closely attached to only one surface of the slave disk, and there is another case in which the master disks are closely attached to both surfaces of a transfer magnetic disk, where magnetic layers have been formed. The latter case is advantageous in that transfer to both the surfaces can be simultaneously performed.

### <Magnetic Transfer Step>

The magnetic transfer step is a step of magnetically transferring magnetic information to the magnetic recording medium by applying a perpendicular magnetic field which acts in the opposite direction to the direction of the magnetic field applied in the initially magnetizing step, with the magnetic recording medium and the magnetic transfer master closely attached to each other.

In the magnetic transfer, while the slave disk and the master disk closely attached to each other are being rotated by a rotating unit (not shown), the recording magnetic field is applied by the magnetic field applying unit, and information in the form of the protrusion pattern, recorded on the master disk, is magnetically transferred to the magnetic layer of the slave disk. Apart from this structure, a mechanism for rotating the magnetic field applying unit may be provided such that the magnetic field applying unit is rotated relatively to the slave disk and the master disk.

FIG. 6 shows a cross section of the slave disk 10 and the master disk 80 in the magnetic transfer step. When the recording magnetic field Hd is applied with a slave disk 10 closely attached to a master disk 80 having the concavo-convex pattern as shown in FIG. 6, a magnetic flux G becomes strong in areas where the convex portions of the magnetic transfer master 80 and the slave disk 10 are in contact with each other, the recording magnetic field Hd causes the magnetization direction of a magnetic layer 88 of the master disk 80 to align with the direction of the recording magnetic field Hd, and thus the magnetic information is transferred to the magnetic layer 16 of the slave disk 10. Meanwhile, at the concave portions of the master disk 80, the magnetic flux G generated by the application of the recording magnetic field Hd is weaker than at the convex portions, and the magnetization direction of a magnetic layer 16 of the slave disk 10 does not change, so that the initially magnetized state remains unchanged.

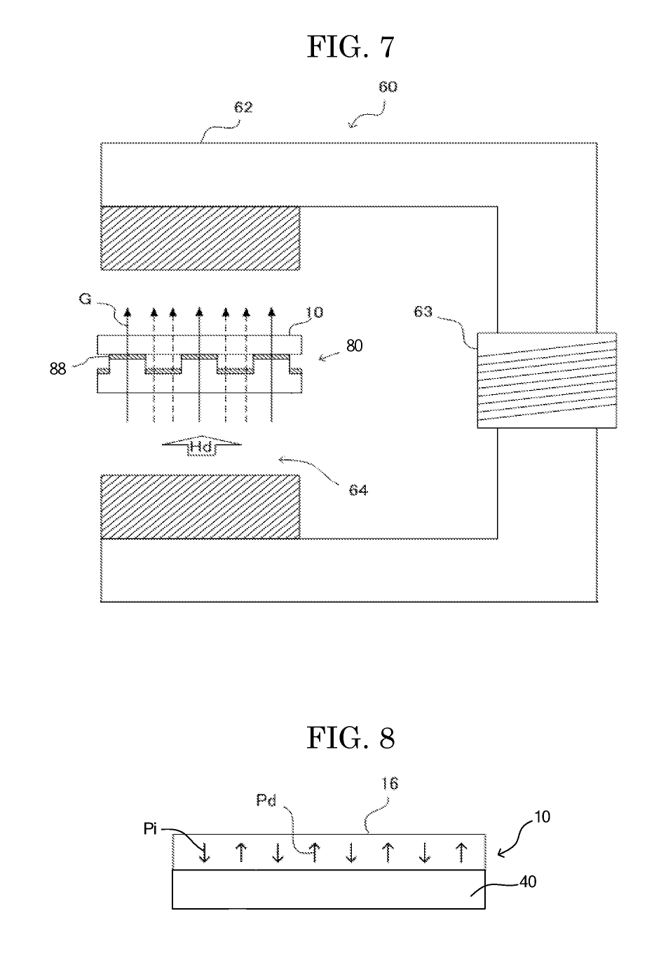

FIG. 7 shows in a detailed manner a magnetic transfer apparatus used for magnetic transfer. The magnetic transfer apparatus includes a magnetic field applying unit 60 composed of an electromagnet which is formed by winding a coil 63 around a core 62. By applying an electric current to the coil 63, a magnetic field is generated in a gap 64 perpendicularly to a master disk 80 and a magnetic layer 16 of a slave disk 10 which are closely attached to each other. The direction of the magnetic field generated can be changed depending upon the direction of the electric current applied to the coil 63. Therefore, both initial magnetization of the slave disk 10 and magnetic transfer can be performed by this magnetic transfer apparatus.

In the case where magnetic transfer is carried out after initial magnetization is performed, using the magnetic transfer apparatus, an electric current which flows in the opposite direction to the direction of an electric current applied to the coil 63 of the magnetic field applying unit 60 at the time of the initial magnetization is applied to the coil 63. This makes it possible to generate a recording magnetic field in the opposite direction to the magnetization direction at the time of the initial magnetization. In the magnetic transfer, while the slave disk 10 and the master disk 80 closely attached to each other are being rotated, the recording magnetic field Hd is applied by the magnetic field applying unit 60, and the information in the form of the protrusion pattern, recorded on the master disk 80, is magnetically transferred to the magnetic layer 16 of the slave disk 10; accordingly, a rotating unit (not shown) is provided. Apart from this structure, a mechanism for rotating the magnetic field applying unit 60 may be provided such that the magnetic field applying unit 60 is rotated relatively to the slave disk 10 and the master disk 80.

In the present embodiment, magnetic transfer is performed by applying as the recording magnetic field Hd a magnetic field which is equivalent in strength to 60% to 130%, preferably 70% to 120%, of the coercive force Hc of the magnetic layer 16 of the slave disk 10 used in the present embodiment.

Thus, on the magnetic layer 16 of the slave disk 10, information of a magnetic pattern, such as a servo signal, is recorded as a recording magnetization Pd which acts in the opposite direction to the direction of the initial magnetization Pi (see FIG. 8).

A magnetic recording medium produced by the magnetic transfer method of the present invention will be used, installed in a magnetic recording and reproducing device such as a hard disk device, for example. This makes it possible to obtain a high-recording-density magnetic recording and reproducing device with high servo precision and excellent recording and reproducing properties.

### EXAMPLES

The following explains Examples of the present invention. It should, however, be noted that the present invention is not confined to these Examples in any way.

### Example 1

### Production of Original Master

An electron beam resist was applied onto an 8 inch silicon (Si) wafer (substrate) by spin coating so as to have a thickness of 100 nm. After the application, the resist on the substrate was exposed using a rotary electron beam exposure apparatus, then the exposed resist was developed, and a resist Si substrate having a concavo-convex pattern was thus produced.

Thereafter, the substrate was subjected to reactive ion etching, with the resist used as a mask, such that concave portions of the concavo-convex pattern enlarged downward. After the etching process, a residual resist on the substrate was washed with a resist-soluble solvent (aching process). Next, the substrate was washed with ultrapure water, rotated at 1,000 rpm to be dried by shaking off for 2 minutes, and further dried in a drying oven at 60° C. for 30 minutes. Thus, an original master was produced,

### —Electroforming Process—

A nickel (Ni) conductive film was formed on the original master by sputtering so as to have a thickness of 20 nm. The original master on which the conductive film had been formed was immersed in a nickel sulfamate bath kept at 55° C., and a Ni film having a thickness of 200 μm was formed by electrolytic plating. Thereafter, the Ni film was separated from the original master by immersing in purified water. Thus, a Ni mold structure was obtained.

### —Formation of Magnetic Layer—

On a surface of the concavo-convex pattern of the produced Ni mold structure, a magnetic layer consisting of 70 at. % of Fe and 30 at. % of Co was formed in a thickness of 100 nm by sputtering under argon pressure of 0.12 Pa, thereby producing a magnetic transfer master,

### —Attachment of Giant-Magnetostriction Element—

Before formation of the giant-magnetostriction element, the surface opposite to the surface, on which the concavo-concave pattern was formed, of the magnetic transfer master was cleaned by oxygen plasma. After cleaning, a Nb film was formed as a non-magnetic underlying layer by introducing Ar gas at 1.0 Pa and applying a voltage of 1,400 W. The Nb film had a thickness of 500 nm.

Next, a giant-magnetostriction element was formed over a surface opposite to the surface, on which the concavo-concave pattern was formed, of the magnetic transfer master by DC magnetron sputtering. That is, the giant-magnetostriction element was formed in such a manner that a Dy—Tb—Fe alloy (TERFENOL-D alloy) as a material for giant-magnetostriction element was deposited in a thickness of 1 μm by DC magnetron sputtering, under the conditions of introducing Ar gas at 1.0 Pa, and applying a voltage of 1,400 W.

Thus, a magnetic transfer master having a giant-magnetostriction element was produced.

### Comparative Example 1

A magnetic transfer master was produced in the same manner as in Example 1, except that the giant-magnetostriction element was not attached thereto. Namely, a normal magnetic transfer master, which was not provided with a member extendable/contractible by an external force, was produced.

### Example 2

The surface opposite to the surface, on which the concavo-concave pattern was formed, of the Ni mold structure produced in Example 1 was cleaned by oxygen plasma. After cleaning, a piezoelectric element was attached onto the Ni mold structure as described below, thereby producing an imprint mold for a discrete track medium (DTM) having a piezoelectric element.

### —Method of Attachment of Piezoelectric Element—

As the piezoelectric element, a quartz wafer having a thickness of 0.6 mm was attached to the surface opposite to the surface, on which the concavo-concave pattern was formed, of the Ni mold structure. As an adhesive, an epoxy resin (ARALDITE) was used.

### Comparative Example 2

An imprint mold for DTM was produced in the same manner as in Example 2, except that the piezoelectric element was not attached thereto. Namely, an imprint mold for DTM, which was not provided with a member extendable/contractible by an external force, was produced.

Next, as to each of the magnetic transfer masters of Examples 1 and Comparative Example 1, a signal quality of a magnetic transfer disk was evaluated as described below. The results are shown in Table 1.

### <Signal Quality of Magnetic Transfer Disk>

The magnetic transfer disk was prepared in such a manner that magnetic information was magnetically transferred to a magnetic layer of a magnetic recording medium by applying a magnetic field, while an initially magnetized magnetic recording medium and each of the magnetic transfer masters of Example 1 and Comparative Example 1 were laid one on top of the other, and a magnetic field was applied to the member (giant-magnetostriction element) of the magnetic transfer master which member is extendable/contractible by an external force, so as to closely attach the initially magnetized magnetic recording medium and the magnetic transfer master to each other. The magnetic recording medium was placed in a drive, and RPE (Repeatable Position Error) was measured and evaluated as follows. Per 100 cylinders, demodulated tracks in 50 rotations were obtained in one cylinder among 100 cylinders. Average values of the demodulated tracks were obtained, and the maximum value of the average demodulated tracks (AM) was calculated. The number of the measured position (error position) in which AM was more than 15 nm was counted:

### [Evaluation Criteria]

A: 5 or less

B: 6 to 10

C: 11 or more

TABLE 1

| | Signal quality of magnetic transfer disk |
|---|---|
| Example 1 | A (3) |
| Comparative Example 1 | C (15) |

The numerals in parentheses are the number of error.

Next, as to each of the imprint molds for DTM of Example 2 and Comparative Example 2, a signal quality of DTM was evaluated as described below. The results are shown in Table 2.

### <Signal Quality of DTM>

A DTM was prepared in such a manner that each of the imprint molds for DTM of Example 2 and Comparative Example 2 was pressed against an imprint resist layer of a magnetic recording medium intermediate, which included a substrate, a magnetic layer on the substrate and the imprint resist layer formed of an imprint resist composition over the substrate, and an electric field was applied to the member (piezoelectric element) of the imprint mold for DTM which member is extendable/contractible by an external force, so as to transfer a concavo-convex pattern onto the imprint resist layer correspondingly to a concavo-convex pattern formed on the imprint mold for DTM. The DTM was placed in a drive, and a tracking test of a magnetic head was performed based on a servo signal. A signal quality of DTM was evaluated in the same manner as the signal quality of the magnetic transfer disk.

TABLE 2

| | Signal quality of DTM |
|---|---|
| Example 2 | A (2) |
| Comparative Example 2 | C (12) |

The numerals in parentheses are the number of error.

The mold structure, and the imprint method and magnetic transfer method using the mold structure, according to the present invention, which can selectively and actively apply an external force to a part of the mold structure, which is not sufficiently closely attached to an object to be processed, so as to maintain a uniform closely attached state, and suitably used for producing magnetic transfer recording media, discrete media, patterned media, or the like.

What is claimed is:

1. A mold structure comprising:
a disc-shaped base material;
a concavo-convex pattern on one surface of the base material; and
a member extendable and contractible by an external force,
wherein the concavo-convex pattern comprises a concavo-convex portion.

2. The mold structure according to claim 1, wherein the member extendable and contractible by the external force is provided on a surface of the mold structure, which surface is opposite to the surface having the concavo-convex pattern.

3. The mold structure according to claim 1, wherein the external force is any one of a magnetic field and an electric field.

4. The mold structure according to claim 1, wherein the member extendable and contractible by the external force is any one of a piezoelectric element and a giant-magnetostriction element.

5. The mold structure according to claim 1, wherein the mold structure is any one of a magnetic transfer master, an imprint mold for a discrete track medium (DTM), and an imprint mold for a bit patterned medium (BPM).

6. An imprint method comprising:
pressing a mold structure against an imprint resist layer of a magnetic recording medium intermediate, and
applying any one of a magnetic field and an electric field to a member of the mold structure which member is extendable and contractible by an external force, so as to transfer a concavo-convex pattern onto the imprint resist layer correspondingly to a concavo-convex pattern of the mold structure,
wherein the mold structure comprises:
a disc-shaped base material;
the concavo-convex pattern on one surface of the base material; and
the member extendable and contractible by the external force,
wherein the concavo-convex pattern comprises a concavo-convex portion, and
wherein the magnetic recording medium intermediate comprises:
a substrate;
a magnetic layer on the substrate; and
the imprint resist layer formed of an imprint resist composition over the substrate.

7. A magnetic transfer method comprising:
initially magnetizing a magnetic recording medium;
superposing and closely attaching a mold structure to the initially magnetized magnetic recording medium by applying any one of a magnetic field or an electric field to a member of the mold structure which member is extendable and contractible by an external force, and
applying a magnetic field to the mold structure and the magnetic recording medium which are closely attached to each other so as to magnetically transfer magnetic information to the magnetic recording medium,
wherein the mold structure comprises:
a disc-shaped base material;
a concavo-convex pattern on one surface of the base material; and
the member extendable and contractible by the external force, and
wherein the concavo-convex pattern comprises a concavo-convex portion.
